(19) United States
(12) Patent Application Publication
(10) Pub. No.: US 2010/0056360 A1
(43) Pub. Date: Mar. 4, 2010

(54) MAGNETIC MESOPOROUS MATERIAL AS CHEMICAL CATALYST

(76) Inventor: Kwangyeol Lee, Namyangju-si (KR)

Correspondence Address: EDWARDS ANGELL PALMER & DODGE LLP, P.O. BOX 55874, BOSTON, MA, 02205, US

(21) Appl. No.: 12/201,838

(22) Filed: Aug. 29, 2008

(51) Int. Cl. B01J 31/02; B01J 21/08; B01J 23/745; B01J 23/75; B01J 23/42; B01J 23/44; B01J 23/46; B01J 23/50; B01J 23/52; B01J 23/34

(52) U.S. Cl. 502/158; 502/232; 502/338; 502/325; 502/326; 502/324; 502/339; 502/347; 502/344

(57) ABSTRACT

Magnetic mesoporous materials as chemical catalyst and methods of making magnetic mesoporous materials as catalyst are provided. The mesoporous materials have mesopores. The mesoporous materials can contain magnetic nanoparticles in wall of the mesoporous material and chemical catalysts in the mesopores. The mesoporous material continaing magnetic nanoparticles and catalysts can be used in a chemical reaction as a catalyst. The mesoporous materials can be removed after the chemical reaction by applying a magnetic field to the chemical reaction medium to isolate the mesoporous materials containing magnetic nanoparticles.

### BACKGROUND

### Description of Related Technology

Mesoporous materials have been used as catalytic support in chemical reactions. These materials are typically dispersed in liquid medium using slight agitation. However, after use, separation of the mesoporous materials after a chemical reaction and subsequent purification of products can be cumbersome.

### SUMMARY

Magnetic mesoporous materials as chemical catalyst and methods of making magnetic mesoporous materials as catalyst are provided. In one embodiment, a magnetic mesoporous material catalyst comprises a mesoporous material comprising mesopores, a chemical catalyst embedded in the mesopores, and magnetic nanoparticles trapped within walls of the mesoporous material.

The Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a schematic of an illustrative embodiment of a method of making magnetic mesoporous material and using the magnetic mesoporous material as catalyst in a chemical reaction.

FIGS. 2A and 2B show schematics of illustrative embodiments of a mesoporous material.

FIG. 3 shows a schematic of an illustrative embodiment of a magnetic nanoparticle.

FIG. 4 shows a schematic of an illustrative embodiment of a mesoporous material with magnetic nanoparticles trapped within walls of a mesoporous material.

FIG. 5 shows a schematic of an illustrative embodiment of a mesoporous material with catalysts being embedded in mesopores.

FIG. 6 shows a schematic of an illustrative embodiment of a chemical reaction with the magnetic mesoporous material containing catalysts.

FIG. 7 shows a schematic of an illustrative embodiment of a process of separating the magnetic mesoporous material from a liquid solution using magnetic field.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the Figures, may be arranged, substituted, combined, and designed in a wide variety of different configurations, all of which are explicitly contemplated and make part of this disclosure.

In one embodiment, a method of making a magnetic mesoporous material catalyst is provided. A mesoporous material that includes mesopores can be employed in this method. The mesoporous material or mesoporous substrate can be a material containing mesopores having diameters from about 1 nm (nanometers) and 50 nm. In one embodiment, the mesopores can have diameters from about 2 nm and to about 10 nm. In some embodiments, the mesopores can have a variety of shapes including circles, hexagons, and etc. The mesopores of the mesoporous material can be generally uniform in size, but need not be substantially uniform. Moreover, the mesoporous material contains pores or gaps in addition to pores in the mesopore size range.

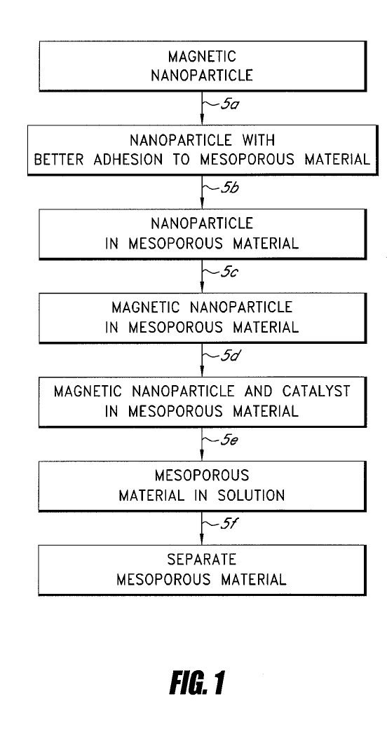

FIG. 1 shows a schematic of an illustrative embodiment of a method of making the magnetic mesoporous material catalyst and using the magnetic mesoporous material catalyst in a chemical reaction. The magnetic mesoporous material catalyst comprises the mesoporous material comprising a plurality of mesopores, chemical catalysts embedded in the mesopores, and magnetic nanoparticles trapped in the walls of the mesoporous material. The magnetic nanoparticles can be, but need not be, substantially uniform in size. In some embodiments, the diameter of the magnetic nanoparticles can be from about 0.1 nm to about 20 nm, such as from 0.5 nm to about 3 nm.

The magnetic nanoparticles can undergo a calcination process 5a to reduce surfactant coating on the surface. The calcination process 5a can include heating the magnetic nanoparticles at temperatures below the melting temperature of the magnetic nanopartcles. In one embodiment, the temperature during the calcination process 50 can be from about 200° C. to about 1500° C., such as about 300° C. to about 1000° C. or about 400° C. to about 900° C. The calcination process 5a can improve adhesion of the magnetic nanoparticles to walls of the mesoporous material by removing a surfactant coating on the surface of the magnetic nanoparticles. However, the magnetic nanoparticles can lose their magnetic property after the calcination process 5a. In some embodiments, the magnetic nanoparticles can be oxidized to metal oxides of the magnetic nanoparticles, such as from Fe₃O₄ to Fe₂O₃, during the calcination process 5a. The magnetic nanoparticles can regain their magnetic property after a latter heat-treatment process.

After the calcination process 5a, the magnetic nanoparticles can undergo a mixing process 5b with one or more precursors of the mesoporous material. The precursors can include a surfactant template (or a structure directing agent) and silica source. In some embodiments, the surfactant template includes an array of rods, sheets, spheres, or etc. The surfactant in the template can include quaternary alkyltrimethylammonium salts, poly tri-block copolymer, etc. In some embodiments, the silica source can include Tetraethyl orthosilicate (TEOS), sodium silicate, amorphous silica, and/or Kanemite. The mixing process 5b can comprise a variety of agitations with the magnetic nanoparticles and the precursors of the mesoporous material. In some embodiments, the mixing process 5b can be performed under hydrothermal conditions. In some embodiments, mixing can include sonication, shaking, swirling, etc. The precursors resulting mixture of precursors and magnetic nanoparticles can be reacted to form a mesoporous material in which the magnetic nanoparticles are trapped within the walls of the mesoporous material to form a magnetic mesoporous material.

After the magnetic nanoparticles are trapped within the walls of the mesoporous material, the magnetic nanoparticles can undergo a heat-treatment process 5c if necessary to regain their magnetic property that can be lost after the calcination process 5a. The heat-treatment process 5c can comprise heating and subsequently heat-treating the magnetic mesoporous material. In some embodiments, the heat-treatment process 5c comprises heating in air at temperature of from about 200° C. to about 1000° C., such as about 400° C. to about 600° C., and subsequently heating at temperature of from about 200° C. to about 2000° C., such as about 500° C. to about 900° C., under reducing atmosphere, such as atmosphere with H₂ in a gas mixture with an inert gas, such as N₂ or Ar. The percentage of H₂ in the gas mixture in some embodiments is from about 1% to about 30% of the gas mixture, such as from about 10% to about 20% of the gas mixture. In some embodiments, heating the magnetic mesoporous material in air can remove surfactants in channels of the mesopores. In some embodiments, the heat-treatment process 5c can reduce the metal oxides of the previous magnetic nanoparticles to initial magnetic nanoparticles. In one embodiment, metal oxide Fe₂O₃ can be reduced to initial magnetic nanoparticle Fe₃O₄ during the heat-treatment process 5c.

A chemical catalyst addition process 5d of the magnetic mesoporous material can provide the magnetic mesoporous material catalyst. In some embodiments, the chemical addition process 5d can include depositing and trapping the chemical catalysts in the mesopores of the magnetic mesoporous material.

The magnetic mesoporous material catalyst can be added to one or more chemical reactants to perform a chemical reaction 5e. In one embodiment, the chemical reaction 5e can include providing reactants for the chemical reaction 5e, adding the magnetic mesoporous material catalyst, and conducting the chemical reaction 5e. The mesoporous material catalyst can perform catalysis during the chemical reaction 5e. In some embodiments, the chemical reaction can include organic reactions, hydrogenation, synthesis, analysis, substitution, metathesis, redox reactions, etc.

After the chemical reaction 5e, the magnetic mesoporous material catalyst can be removed to purify a chemical product. A separation process 5f can help isolation of the magnetic mesoporous material catalyst. The magnetic mesoporous material catalyst containing the magnetic nanoparticles can be separated by applying a magnetic field to the liquid medium containing the magnetic mesoporous material catalyst and the chemical product. In one embodiment, the applying of the magnetic field attracts the magnetic mesoporous material catalyst. In another embodiment the applying of the magnetic field repels the magnetic mesoporous material catalyst.

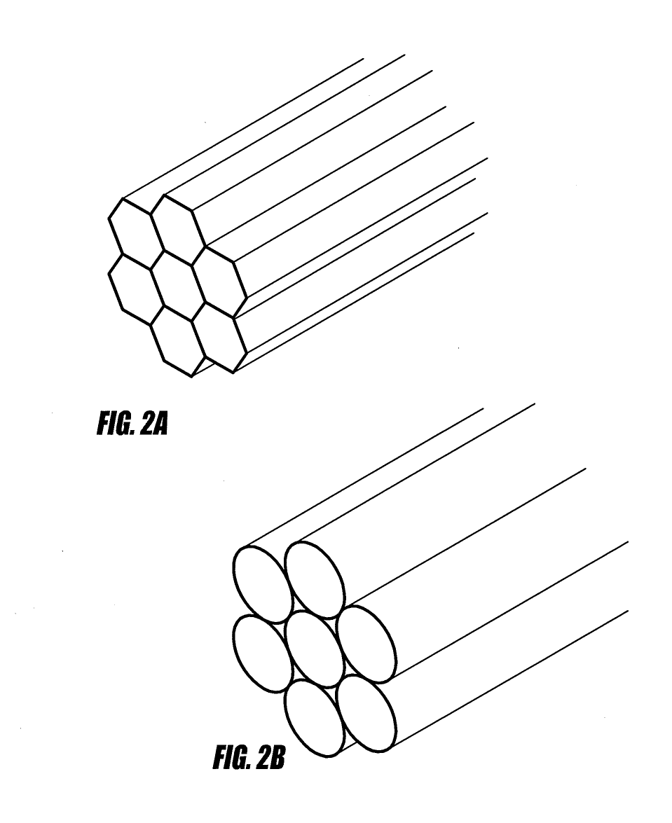

FIGS. 2A and 2B show schematics of illustrative embodiments of a mesoporous material or mesoporous substrate 10 comprising mesopores 11. As shown, the mesoporous material 10 can be a collection of nano-sized spheres, rods, or sheets that are filled with a regular arrangement of pores. However, the mesoporous material 10 can take on any of a variety of shapes and forms. At least one dimension of the mesoporous material 10 can be from about 10 nm to about 1000 nm. In some embodiments, the mesoporous material 10 can be formed of a variety of materials, such as mesoporous silica, or mesoporous metal oxides. In one embodiment, the mesoporous material is MCM (Mobile Composition of Matter)-41, MCM-48, or SBA-15 (Santa Barbara Amorphous type material). As shown in FIG. 2A, the mesopores 11 can be arranged in substantially uniform hexagonal arrays. In another embodiment as shown in FIG. 2B, the mesopores 11 can have circular cross-sections and can be elongated as tubular channels. However, other embodiments may have different arrangements of mesopores 11, and the mesopores 11 can also be dispersed in substantially random locations of the mesoporous material 10.

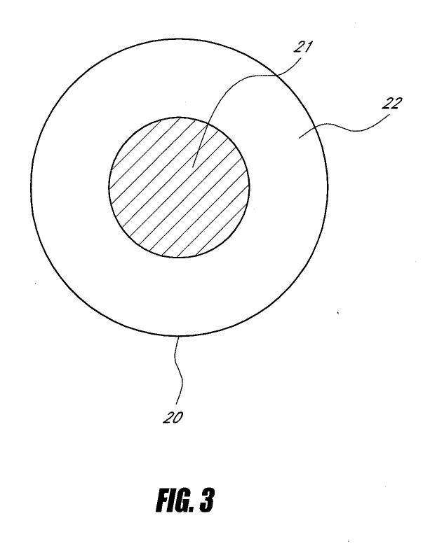

FIG. 3 shows a schematic of an illustrative embodiment of a magnetic nanoparticle 20 that can be embedded in the mesopores 11 of the mesoporous material 10. In one embodiment, the magnetic nanoparticles 20 can comprise an inner magnetic core 21 and an outer shell 22, where the outer shell 22 has more adhesion to the mesopores 11 than the inner magnetic core 21. The inner magnetic core 21 can be magnetic and provide the magnetic property of the magnetic nanoparticle 20. The outer shell 22 can have properties that permit the mesopores 11 to adhere to the mesopores 11 of the mesoporous material 10. The inner magnetic core 21 of the magnetic nanoparticle 20 can include metal oxides, such as Fe₃O₄, Co, cobalt oxide, Fe₂AnO₄, Fe₂CoO₄, Fe₂MnO₄, FePt, etc. The outer shell 22 can include material similar to the mesoporous material 10. Thus, in one embodiment, the outer shell 22 can include SiO₂ or metal oxide.

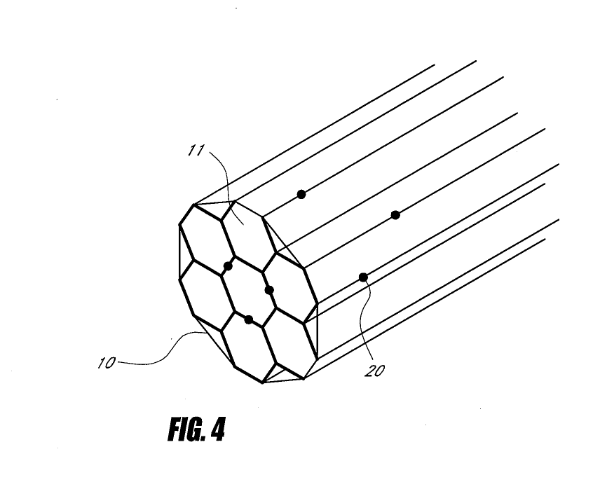

FIG. 4 shows a schematic of an illustrative embodiment of the mesoporous material 10 with the magnetic nanoparticles 20 trapped within the walls of the mesoporous material 10. The mixing process 5b (of FIG. 1) can deposit and trap the magnetic nanoparticles 20 within the walls of the mesoporous material 10.

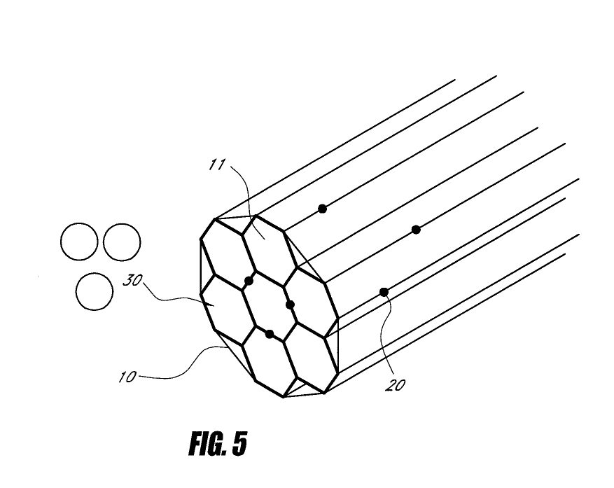

FIG. 5 shows a schematic of an illustrative embodiment of the mesoporous material 10 with catalysts 30 being embedded in the mesopores 11 during the chemical catalyst addition process 5d (of FIG. 1). In one embodiment, the chemical catalysts 30 can be added to the mesoporous material 10 by mixing the chemical catalyst 30 with the mesoporous material 10. One or more chemical catalysts 30 can be added. As described above, the chemical catalyst 30 can include Pd, Pt, Au, Ag, Ru, Os, Rh, Ir, binary alloys, or ternary alloys. In one example, the chemical catalyst 30 can include platinum group metals that can be used in hydrogenation reaction. The size of the chemical catalyst is generally smaller than the mesopores 11, such as from about 1 nm and to about 10 nm. The mesoporous material 10 containing the magnetic nanoparticles 20 and the chemical catalyst 30 can be used in a chemical reaction 5e (of FIG. 1).

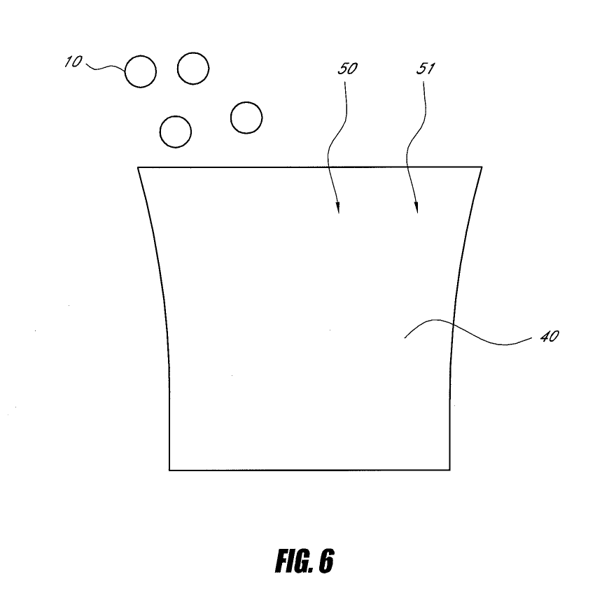

FIG. 6 shows a schematic of an illustrative embodiment of the chemical reaction 5e with the mesoporous material 10 containing the magnetic nanoparticles 20 and the chemical catalyst 30. The chemical reaction 5e can be performed in a liquid medium 40. One or more reactants, such as 50 and 51 can be added to the liquid medium 40 for the chemical reaction 5e. The mesoporous material 10 containing the chemical catalysts 30 and the magnetic nanoparticles 20 can be added to the liquid medium 40 containing reactants 50 and 51 to lower the activation energy of the chemical reaction 5e. The chemical reaction 5e can be performed to make pharmaceutical drugs, polymers, chemical solutions, etc.

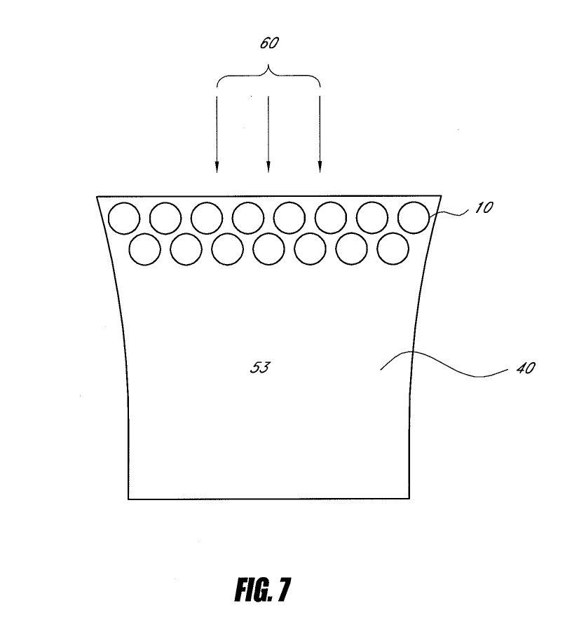

FIG. 7 shows a schematic of an illustrative embodiment of the separation process 5f (of FIG. 1) of the mesoporous material 10 after the chemical reaction 5e (of FIG. 1). A product 53 of the chemical reaction 5e can form in the liquid medium 40 while the mesoporous material 10 remains in the liquid medium 40. In one embodiment, more than one product can be formed. The mesoporous material 10 containing the magnetic nanoparticles 20 can be magnetic. A magnetic field 60 can be applied to the liquid medium 40 to attract or repel the mesoporous material 10 containing the magnetic nanoparticles 20. An attraction or a repulsion of the mesoporous material 10 with the magnetic field 60 can isolate the mesoporous material 10 from the product 53. An isolation of the mesoporous material 10 helps separation of the mesoporous material 10 from the liquid medium 40. The magnetic field 60 can be applied using any source thereof, such as electromagnet or magnet.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method of making a magnetic mesoporous material catalyst, the method comprising:
mixing magnetic nanoparticles with one or more precursors of a mesoporous material;
forming the mesoporous material comprising a plurality of mesopores from a mixture of the magnetic nanoparticles with the precursors of the mesoporous material, wherein the magnetic nanoparticles are trapped within walls of the mesoporous material; and
adding catalysts to the mesoporous material, wherein the catalysts are deposited and trapped in the mesopores.

2. The method of claim 1, wherein the precursors comprise a silica source and a surfactant template.

3. The method of claim 2, wherein the silica source comprises Tetraethyl orthosilicate (TEOS), sodium silicate, or amorphous silica.

4. The method of claim 2, wherein the surfactant template comprises an array of spheres, rods, and/or sheets.

5. The method of claim 1, wherein the mixing comprises mixing by sonication.

6. The method of claim 1, wherein the method further comprises making the magnetic nanoparticles, wherein the making comprises:
enclosing an inner magnetic core with an outer shell having more adhesion to the mesoporous material than the inner magnetic core.

7. The method of claim 1, the method further comprises calcinating the magnetic nanoparticles before mixing, wherein calcinating removes a surfactant coating on the surface of the magnetic nanoparticles and improve adhesion of the magnetic nanoparticles to the walls of the mesoporous material.

8. The method of claim 7, wherein the magnetic nanoparticles lose their magnetic property after calcinating.

9. The method of claim 1, the method further comprises heating and subsequently heat-treating the mesoporous material containing the magnetic nanoparticles after the mixing.

10. The method of claim 9, wherein the heating comprises heating in air at temperature of from about 400° C. to about 600° C.

11. The method of claim 9, wherein the heat-treating comprises heating at temperature of from about 500° C. to about 900° C. in the presence of H₂/N₂ mixture gas with H2 from about 1% to about 20% of the mixture.

12. The method of claim 9, wherein the magnetic nanoparticles regain their magnetic property after heat-treating.

13. A magnetic mesoporous material catalyst, comprising:
a mesoporous material comprising a plurality of mesopores;
a plurality of magnetic nanoparticles trapped within walls of the mesoporous materials, wherein the magnetic nanoparticles comprise an inner magnetic nanoparticle and an outer shell, the outer shell having more adhesion to the mesoporous material than the inner magnetic nanoparticle; and
a chemical catalyst embedded in the mesopores.

14. The magnetic mesoporous material catalyst of claim 13, wherein the mesoporous material comprises mesopores with diameter from about 2 nrn and to about 10 nm.

15. The magnetic mesoporous material catalyst of claim 13, wherein the mesopores comprise cross-sections such as circles or hexagons.

16. The magnetic mesoporous material catalyst of claim 13, wherein the mesoporous material comprises mesoporous silica, or mesoporous metal oxides.

17. The magnetic mesoporous material catalyst of claim 16, wherein the mesoporous material comprises MCM-41, SBA-15, and MCM-48.

18. (canceled)

19. The magnetic mesoporous material catalyst of claim 18, wherein the inner magnetic nanoparticle comprises Fe₃O₄, Co, cobalt oxide, Fe₂AuO₄, Fe₂CoO₄, Fe₂MnO₄, or FePt.

20. The magnetic mesoporous material catalyst of claim 18, wherein the outer shell comprises SiO2.

21. The magnetic mesoporous material catalyst of claim 13, wherein the chemical catalysts comprise Pd, Pt, Au, Ag, Ru, Os, Rh, Ir, binary alloys, or ternary alloys.

22. A method of catalyzing a chemical reaction, comprising:
adding catalysts to a mesoporous material comprising mesopores, wherein the catalysts get embedded in the mesopores;
adding reactants for the chemical reaction to the mesoporous material containing catalysts;
conducting the chemical reaction; and
applying a magnetic field to separate the mesoporous material from reaction products of the chemical reaction.

23. The method of claim 22, wherein the applying of the magnetic field attracts the magnetic mesoporous material.

24. The method of claim 22, wherein the applying of the magnetic field repels the magnetic mesoporous material.

25. The method of claim 22, wherein conducting the chemical reaction comprises conducting chemical reaction in a liquid medium.

26. The method of claim 22, wherein the chemical reaction is used in production of pharmaceutical drugs.
